(19) United States
(12) Patent Application Publication
(10) Pub. No.: US 2005/0200087 A1
(43) Pub. Date: Sep. 15, 2005

(54) Rotary tool with quick connect means and attachments thereto

(76) Inventors: Kailash C. Vasudeva, Waterloo (CA); Scott W. Allan, Kitchener (CA); Satnam Singh, Kitchener (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 11/079,319

(22) Filed: Mar. 15, 2005

Related U.S. Application Data
(60) Provisional application No. 60/552,734, filed on Mar. 15, 2004.

(51) Int. Cl. B23B 31/02

(52) U.S. Cl. 279/143

(57) ABSTRACT

The present invention is directed at a handheld power tool comprising means for receiving a tool accessory; means for rotating said tool accessory; and at least one quick connect means for use with power tool attachments.

### CROSS-REFERENCE TO RELATED APPLICATIONS

This application claims the benefit of U.S. Provisional Application No. 60/552,734 filed Mar. 15, 2003, which is incorporated herein by reference.

### FIELD OF THE INVENTION

The present invention relates generally to electric powered rotary tools. More particularly, the present invention relates to a hand held power tool with a rotational motor having quick connect means.

### BACKGROUND OF THE INVENTION

It can be appreciated that rotary tools have been used for many years. Rotary tools are generally used with accessories and attachments. Each can be sold separately or combined as a set in various combinations. While accessories are used for rotary tool applications such as cutting, grinding, polishing, routing trimming among others, the attachments are used to assist the user for specific tasks. A common example of this is a cutting guide attachment that is installed onto the rotary tool for use with a cutting accessory to guide the cutting path of the rotary tool in a controlled manner relative to a work-piece. Other attachments available include work lights, tool and blade sharpeners, a grout removal guide, holders, flexible shaft extensions, routing attachments, drilling attachments and shaper tables.

Connection means for receiving the attachments typically comprise of two methods. One method is to have a threaded portion at a spindle end of the tool housing. The attachment is then screwed onto this portion and secured for use. When the attachment is not connected, a housing nut is placed over the threads to protect them. A second method of connection between the attachment and the rotary tool is with circumferential clamps surrounding the tool housing which are securely tightened with thumb or machine screws. Circumferential clamps are often integrated with the attachment.

Connection means for the accessory typically comprise a clamping head or a chuck on the shaft of the accessory. The chuck comprises a split collar and tightening nut whereby the tightening nut screws onto a threaded portion of the spindle. One end of the spindle end is affixed to the tool motor and the other end collaborates with the chuck to secure the accessory from rotation relative to the spindle when tightened in order to lock and prepare for use. In order for the clamping mechanism to work effectively, the spindle thread is required to be a high threads-per-inch count thereby requiring many rotations to loosen and tighten the nut over a given axial distance with an even more significant amount of rotation to remove the nut altogether. This is obviously quite time consuming.

Each exchange, removal or addition of any attachment or accessory involves a process of shutting off the tool, waiting for the tool to fully stop, loosening the attachment securing mechanism, removing the accessory or attachment, exchanging the attachment, and repeating the process in reverse to re-secure the attachment or a new attachment. In some cases where the accessory is larger than the inner diameter of the housing nut, this process needs to be performed for both the chuck and the housing nut in sequence to complete the installation which requires more time. When considering the multitude of accessories combined with the multitude of attachments, a significant disadvantage of the known art is recognized. More specifically, the exchange of accessories or attachments is very time consuming and cumbersome which may frustrate the user and deter them from making the best use of their rotary tool. The time required to connect the chuck to the spindle, any attachment to the threaded portion of the tool housing and any attachment of clamps to the tool housing prolongs the time in which a user may finish the job.

Aside from the foregoing there are several other disadvantages of the connection means in the known art, not the least of which is the threaded connection. While this method of attachment is a widely accepted practice for connecting an attachment to a rotary tool, its application in high RPM rotary tools causes loosening and tightening over time. In the example of the tightening nut on the spindle, a common problem is that over time the nut tightens resulting in the need to use a wrench to loosen the clamp prior to exchanging accessories and attachments. The threaded connection can also cause an adverse effect and loosen the connection resulting in loss of functionality of the attachments or accessories and even worse, unsafe tool operation.

Threaded connections cause the user to be uncertain as to how much torque on the connection is required for proper installation. Again, if the threaded connection is too loose, operation of the rotary tool and safe operation is jeopardized and conversely if the connection is too tight, undue strain or even fracture of the components adjacent to the connection may be experienced. Many product components are manufactured with thermoplastic and therefore cannot withstand such forces, causing irreparable damage. This problem may relate to either connection means for the attachments to the rotary tool housing or with any connect means which include a threaded portion. If the fracture is undetected, this leads to even a greater risk of harm to the operator.

Yet another disadvantage of the threaded connection is its difficulty to obtain axial and radial location referencing or predicted axial and radial displacement. Common, cost effective thread manufacturing methods generally do not provide reliable axial location of attachments with respect to the accessory and the work-piece. Several applications of a rotary tool may benefit from consistent and reliable location positioning.

Another problem with conventional rotary tools is it offers limited storage options after or during use. Most rotary tools are provided with a wire hanger and a storage box but storage capability is limited to such and does not offer the capability for customized storage options. Providing the capability for the tool to be stored on a workbench, on a stand, on your belt, on the wall, in a portable workstation among other areas would improve storage options for the user.

Rotary tools currently on the market have been designed for indoor use or in environments with controlled conditions. Provisions have not been provided to use the tool in applications for outdoor, uncontrolled or otherwise harsher environments.

Traditionally, rotary tools have also been designed to be substantially cylindrical. This shape is not conducive to providing the user with ergonomic comfort, a variety of gripping options, a tool that does not roll off the workbench, adaptability to various applications among others.

Use of the rotary tool is also more prominent in do-it yourself applications rather than industrial applications. It would be obvious that with all the inherent disadvantages of the known art there are several limiting factors that would prevent more standard use of this tool in industrial applications. Contractors, professionals, small business owners rely on tools that are designed to improve efficiencies of use because their profitability relies on this.

It is, therefore, desirable to provide a rotary tool having quick connect means which overcomes the disadvantages or the prior art.

### SUMMARY OF THE INVENTION

It is an object of the present invention to obviate or mitigate at least one disadvantage of prior art handheld power tools. The present invention is directed at a handheld power tool with quick connect means which provides better functionality for several uses.

Thus in the invention, the handheld power tool provides means for quick connect and removal of attachments in order to reduce the amount of time required to finish a job. The quick connect means also allow for improved flexibility in handheld power tool applications and/or improved user safety and comfort and universality for general or specific application design and use.

The present invention generally comprises universal connecting means for attaching an attachment to the handheld power tool. The quick connect means may be located at the spindle, the end of the handheld power tool, a power end of the handheld power tool, the housing surface of the handheld power tool or a combination thereof. The invention even further comprising of auto-locking and quick releasing securing means to the quick connect means.

A first aspect of the present invention is to provide a handheld power tool with quick connect means that will overcome the shortcomings of the prior art devices.

Another aspect of the present invention is to provide a handheld power tool having quick connect means that is universal in construction such that the handheld power tool housing can be created with at least one mating portion of a connection and multiple attachments are constructed with the opposing mating portion.

Another aspect of the invention provides a handheld power tool having quick connect means on the larger diametrical portion of the tool housing and/or the spindle end of the tool housing so as to create a connectivity for smaller attachments at the spindle end, connectivity for larger attachment around the larger portion of the housing and multiple connectivity for other attachments that would benefit from the added strength and stability of multiple connections.

In another aspect of the invention, there is provided a handheld power tool having quick connect means such that the connection and disconnection is quick and simple so as to facilitate efficient exchange of attachments.

In a further aspect, there is provided a handheld power tool having quick connect means such that when the attachment is installed (or connected), the attachment may be easily secured. It is a further aspect to provide an optional auto-locking and quick release feature in the attachments for such securing means.

Another aspect of the invention is to provide a handheld power tool having quick connect means on the distal end of the spindle so as to facilitate quick removal and installation of the accessory chuck.

Another aspect of the invention provides a handheld power tool having quick connect means for receiving various attachments that assist to improve the connectivity of attachments for various handheld power tool applications and to create new attachments that otherwise may have been technically and cost prohibitive with the conventional quick connect means.

In one aspect of the present invention, there is provided a harness for providing quick connect means to a handheld power tool having a rotational motor comprising: a first holder portion for attachment to one end of the handheld power tool; a second holder portion for attachment to a second end of the handheld power tool; means for securing the first and the second holder portion to the handheld power tool; an attachment portion connecting the first holder portion to the second portion; and wherein the attachment portion further comprises quick connect means for receiving a handheld power tool attachment.

In another aspect, there is provided a handheld power tool attachment comprising at least one mating means for mating with quick connect means on a handheld power tool with a rotational motor.

In yet a further aspect, there is provided handheld power tool comprising means for receiving a tool accessory; means for rotating the tool accessory; and at least one quick connect means for use with handheld power tool attachments.

Other objects and advantages of the present invention will become obvious to the reader and it is intended that these aspects and advantages are within the scope of the present invention.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein;

FIG. 1 is a perspective view of a rotary tool having quick connect means;

FIG. 2 is a perspective view of the rotary tool of FIG. 1 along with attachments for connecting with the quick connect means;

FIG. 3 is an exploded view of the rotary tool of FIG. 1 of an attachment and one of the quick connect means;

FIG. 4 is an exploded view of the rotary tool of FIG. 1 of an attachment and another one of the quick connect means;

FIG. 5 is an exploded view of the of the rotary tool of FIG. 1 of an attachment and another one of the quick connect means;

FIG. 5a is a perspective view of one embodiment of the quick connect means;

FIG. 6 is a perspective view of a rotary tool having quick connect means being mounted to a base attachment;

FIG. 7 is a perspective view of another embodiment of a rotary tool having quick connect means and an attachment for connecting with the quick connect means;

FIG. 8 is a perspective view of yet another embodiment of a rotary tool having quick connect means and an attachment for connecting with the quick connect means;

FIG. 9 is a perspective view of a rotary tool having quick connect means mounted to a portable workstation;

FIG. 10 is a perspective view of a rotary tool having quick connect means with an attachment connected to the quick connect means;

FIG. 11 is a perspective view of a rotary tool having quick connect means with another embodiment of an attachment connected to the quick connect means;

FIG. 12 is a perspective view of a rotary tool having quick connect means with another embodiment of a rotary tool attachment connected to the quick connect means;

FIG. 13 is a perspective view of a rotary tool having quick connect means with two attachments connected to the quick connect means;

FIG. 14 is a perspective view of a rotary tool having quick connect means with a single attachment connected to multiple quick connect means;

FIG. 15 is a side view of a rotary tool having quick connect means with an attachment, shown in section, connect to the quick connect means;

FIG. 16 is a perspective view of a rotary tool having quick connect means attached to a router table attachment;

FIG. 17 is a section view along line 17-17 of FIG. 16;

FIG. 18 is a perspective view of a rotary tool having quick connect means with another rotary tool attachment connected to the quick connect means;

FIG. 19 is a perspective view of a harness having quick connect means for mounting to a known rotary tool to provide a rotary tool having quick connect means;

FIG. 20 is a perspective of a rotary tool having quick connect means connected to a flex shaft having quick connect means;

FIG. 21 is a perspective view of a rotary tool having quick connect means mounted to a portable workstation attachment;

FIG. 22 is a perspective view of a rotary tool having quick connect means mounted to the outside of a portable workstation;

FIG. 23 is a perspective view of a rotary tool having quick connect means and a power cord attachment for connecting with the quick connect means;

FIG. 24 is a perspective view of the rear of the rotary tool of FIG. 23;

FIG. 25 is a perspective view of a rotary tool having quick connect means and a battery pack attachment for connecting with the quick connect means; and

FIG. 26 is a perspective view of the attachment in FIG. 25 connected to the quick connect means.

### DETAILED DESCRIPTION OF THE INVENTION

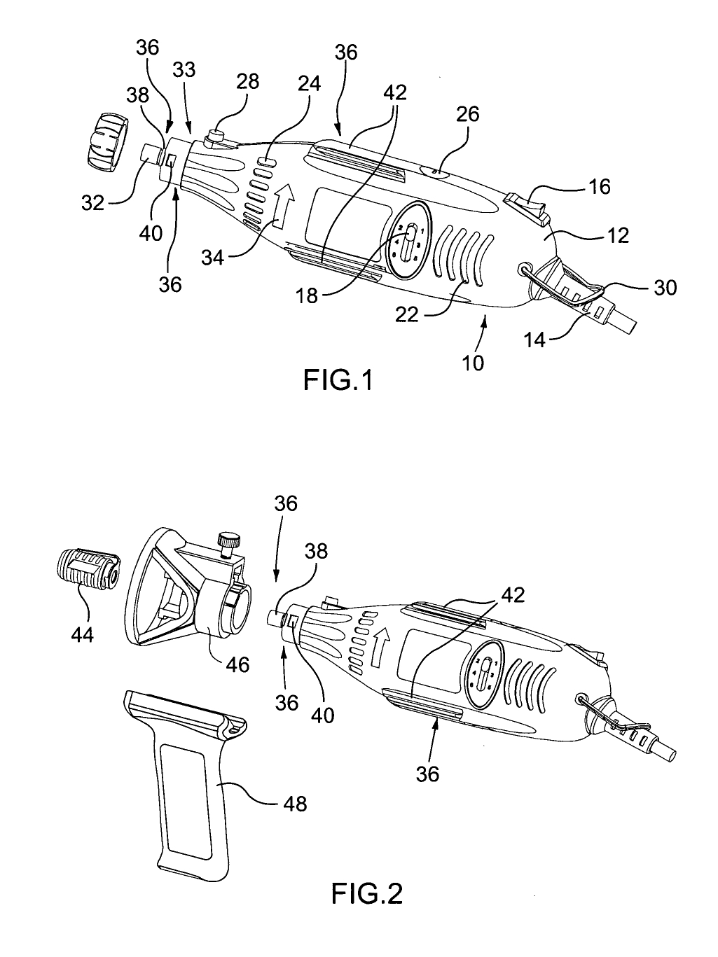

Turning to FIG. 1, a hand held power tool with a rotational motor, or rotary tool, having a plurality of quick connect means is shown. It will be understood that the rotational motor may turn in a single direction or may be bidirectional such as in a drill (which may also be considered a rotary tool). Although the following detailed description is directed at rotary tools, it will be understood that handheld power tools having bidirectional rotational motors, for example, a drill, may also include the described quick connect means. The rotary tool 10 comprises a housing 12 which houses a motor (not shown) and a power cord 14 having a first end connected to the motor and a second end protruding from the housing 12 of the rotary tool 10. Although not shown, the second end of the power cord 14, preferably includes means for connecting the power cord 14 to a power source in order to provide power to the rotary tool 10. Operation of the rotary tool 10 is controlled by a power switch 16 while the rotational speed of the tool is preferably controlled by a speed adjustment button 18, both of which are in electrical communication with the motor. Although shown in this embodiment as being separate controls, it will be understood that the power switch 16 and speed adjustment button 18 may be provided in a single control.

The rotary tool 10 further comprises an intake air vent 22 which is used to draw atmospheric air into the housing 12 in order to cool the motor and an exhaust air vent 24 which is used to release heated air that is produced by the motor while the rotary tool is being used. In the present embodiment, the rotary tool also includes a motor brush access 26, a shaft lock button 28 and a tool hanger 30, all of which will be known to one skilled in the art.

A spindle end shaft 32 is located at a tool end 33 of the rotary tool 10 and is directly attached to or manufactured integral with the motor in the housing 12 such that when the motor is in operation, the motor causes the spindle end shaft 32 to rotate and provide the necessary rotational movement for the rotary tool to operate. Since the rotation of the rotary tools is typically uni-directional, the housing 12 may include an arrow 34 to indicate the direction of rotation of the tool with respect to the housing 12. It will be understood that if the rotary tool was a drill, the arrow could have two ends or the arrow could be removed from the housing 12.

As disclosed above, the rotary tool 10 also includes a plurality of quick connect means 36 such as a spindle end quick connect means 38, a tool housing end quick connect means 40 and a housing surface quick connect means 42. Although the housing surface quick connect means 42 are shown at the top and bottom of the rotary tool 10, it will be understood that there are many possible locations for these quick connect means 42. Furthermore, it will be understood that there may be any combination of the described quick connect means 36 rather than each rotary tool comprising all of the different quick connect means 36. The quick connect means 36 of the present invention are preferably universal in nature so as to facilitate the connection of the rotary tool with a multitude of attachments.

Turning to FIG. 2, the rotary tool is shown with some example attachments. As described above, the rotary tool 10 includes quick connect means 36 for receiving, or connecting to, attachments which preferably enhance the functionality of the rotary tool 10. In FIG. 2, an accessory chuck attachment 44 is shown which may be mounted, or connected to, the spindle end quick connect means 38, a cutting guide attachment 46 which may be mounted, or connected to, the tool housing end quick connect means 40 and a handle 48 which may be mounted, or connected to, one of the tool housing surface quick connect means 42. More detail relating to the connection of the attachments with the quick connect means 36 will be described below.

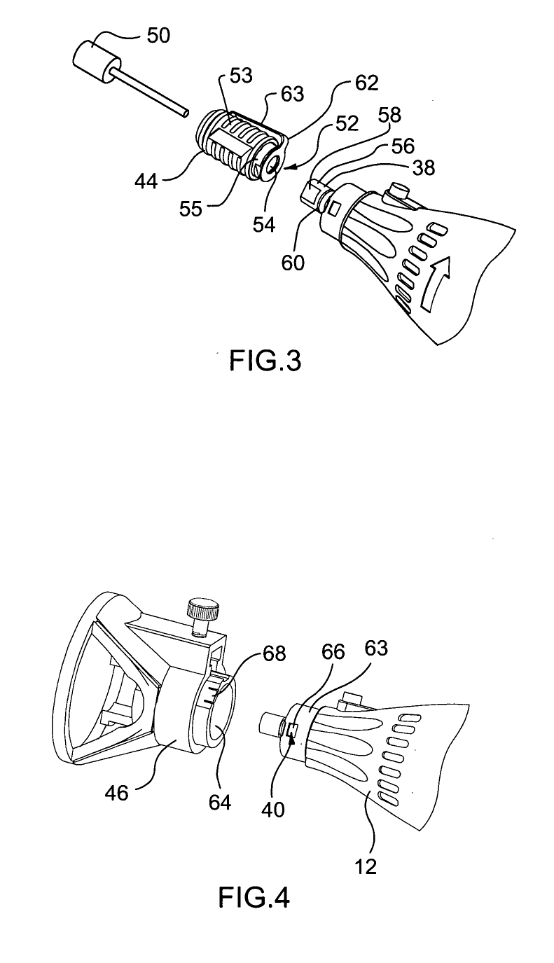

Turning to FIG. 3, a schematic diagram of one embodiment of the quick connect means is shown. The accessory chuck attachment 44 is preferably mounted, or connected to, the spindle end quick connect means 38 at one end and accepts an accessory, such as tool accessory 50, at a second end.

In the embodiment shown in FIG. 3, the accessory chuck attachment 44 comprises mating means, seen as a mating section, 52, a sleeve 53 and a hole 54 bored through a body 55 of the accessory chuck attachment 44. The chuck attachment 44 also includes a clamp lock 62 which serves as a means for axial location, auto-locking and quick releasing for the tool accessory 50.

The spindle end quick connect means 38 preferably comprises a substantially round shaft (seen as a mating section) 56 with a flat section 58 around a portion of the perimeter of the shaft 56. The shape of the mating section 52 is manufactured to correspondingly fit with the shaft 56 of the spindle end quick connect means 38. It will be understood that FIG. 3 is not drawn to scale and that the mating section 56 should fit within the mating section 52. The spindle end quick connect means 38 also includes an groove 60 around the shaft 56 so as to provide a means for mating with the clamp lock 62. The clamp lock 62 comprises a clip 63 of a spring-like material which is secured onto the accessory chuck attachment 44 to engage the groove 60 when the accessory chuck attachment 44 is fully inserted into an installed position thus securing the accessory chuck attachment 44 to the spindle end quick connect means 38. The groove 60 also serves to axially locate the position of the attachment with respect to the rotary tool and the quick connect means.

When the rotary tool is turned on, the motor causes the spindle end shaft 32, and therefore the flat section 58, to rotate which in turn, causes the flat section 58 to drive the accessory chuck attachment 44 relative to the motor in the housing 12. This rotational movement causes the clamp to move due to centrifugal forces but this movement further secures the attachment to the quick connect means by tightening the connection in the groove. The rotational movement also causes the tool accessory 50 to rotate thereby rendering the rotary tool operational. It is preferred that the fit between the spindle end quick connect means 38 and the mating section 52 be relatively free of play to ensure a proper and functioning connection between the accessory chuck attachment 44 and the spindle end quick connect means 38.

FIG. 4 provides a view of an attachment for connection with the tool housing end quick connect means 40. As with the other quick connect means 26, the tool housing end quick connect means 40 provides support to and connection for attachments that operate in conjunction with any rotary tool accessories.

In FIG. 4, the cutting guide attachment 46 comprises mating means 64 for connecting the cutting guide attachment 46 to the tool housing end quick connect means 40. The tool housing end quick connect means 40 comprises a cylindrical portion 63 which mates with the mating means 64 (seen as a hole) in the cutting guide attachment 46. It is preferred that the fit of the cylindrical portion 63 and the hole 64 be such that the cylindrical portion 63 compliments the hole 64. The quick connect means 40 further comprises a slot 66 for receiving and guiding a corresponding clip 68 in the mating means 64 of the cutting guide attachment 46. When connected, the clip 68 fits within the slot 66 until it locked in an installed position. By locking the clip 68 in the slot 66, the attachment is further prevented from axial displacement while the rotary tool 10 is being used. The connection between the clip and the slot may be further supported by a keyway to further assist in preventing the chuck attachment from moving.

It will be understood that this is simply one method of providing tool housing end quick connect means and that other means for quickly locking and releasing attachments to and from the rotary tool may be contemplated.

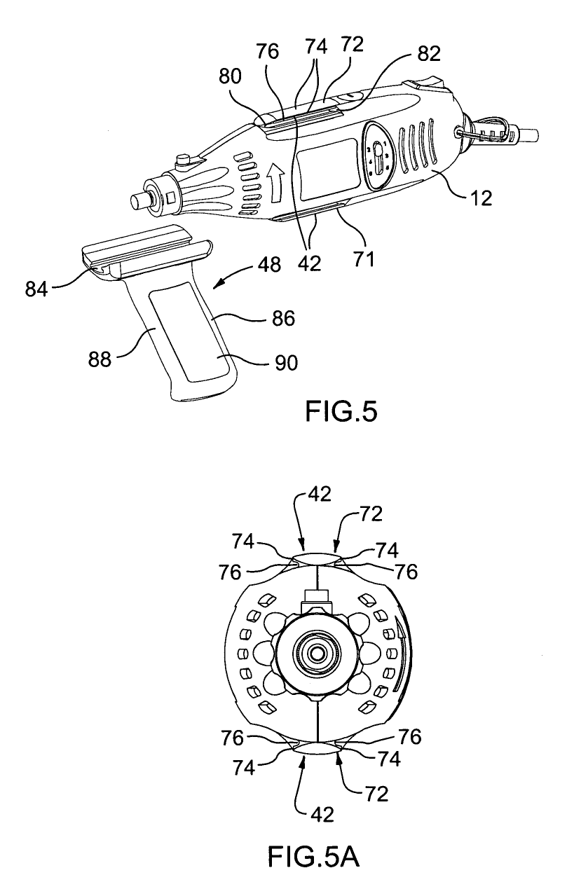

FIG. 5 provides a view of an attachment for connecting with the housing surface quick connect means 42. The housing surface quick connect means are preferably formed as an integral part of the tool housing, and more specifically via an injection moulding, preferably single-shot. The housing surface quick connect means may also be assembled to the housing of the rotary tool. The attachment for this quick connect means, seen as the handle, 48 comprises mating means 84 allowing the handle to be connected to the housing surface quick connect means 42. The attachment 48 further comprises a handle 86 and ergonomically shaped surfaces 88 and 90 which provide a comfortable grip for a user's hand. In the present embodiment, the housing surface quick connect means 42 comprise a dovetail type connection 71 along a portion of the housing 12 in a longitudinal direction for mating with the mating means 84 of the attachment 48. Alternatively, the connection may be in the form of T-slot, recess and projection, magnetic or other types of connections. In this embodiment, there are two quick connect means on opposite sides of the tool so as to provide symmetrical quick connect means and to facilitate the mounting of two separate attachments on opposite sides of the rotary tool 10.

As further shown in FIG. 5a, each dovetail-type connection 71 comprises a surface 72 which is preferably co-planar with the surface of the housing 12, a pair of edges 74 generally parallel to a longitudinal axis of the rotary tool 10, an inwardly angled surface 76 from each edge 74 resulting in a distance between the edges 74 greater than a distance between the ends of the angled surfaces 76 to receive the attachment 18. At a distal end of the housing surface quick connect means 42 is a lead-in 80 and at an opposing end of the housing surface quick connect means 42 is a stop-wall 82.

The lead-in 80 provides a guide for guiding the attachment after the mating means of the attachment and the dovetail connection have been mated. The stop-wall 82 serves as a location reference point on the tool housing 12 and as a perpendicular stop to the attachment 48 when it is connected to the housing surface quick connect means 42. The connection between the mating means 84 of the attachment 48 and the dovetail connection 71 of the housing surface quick connect means 42 may be provided with various types of fits including a loose fit, a location fit, a transitional fit or even an interference fit depending on the type and use of the attachment. Additional securing means may also be applied to the housing surface quick connect means 42 for attachments which require stronger locking or securing means.

It will be understood that many alternative configurations and properties for housing surface quick connect means 42 may be appreciated such as location, quantity and form.

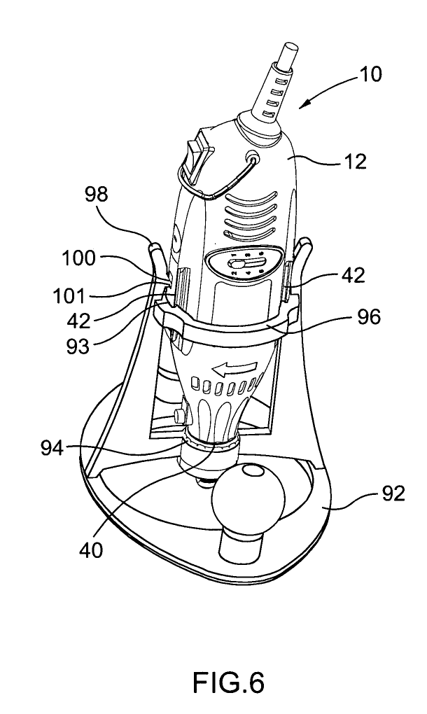

FIG. 6 provides another diagram of a rotary tool having quick connect means attached to a base. The rotary tool 10 is connected to a router base attachment 92 via the tool housing end quick connect means 40 and the housing surface quick connect means 42. In the present embodiment, the connection is facilitated by the two different quick connect means 36 and support means. The router base attachment 92 comprises a first support 94 which mates with the tool housing end quick connect means 40 and a second support 96 which mates with both tool housing surface quick connect means 42. By connecting the rotary tool 10 to the router base attachment 92 at multiple locations, substantial support and multiple connection points are provided. The attachment 92 further comprises a mating recess 93 which is configured to cooperatively fit with the tool housing surface quick connect means 42. An extension 98 of the attachment 92 comprises a tab 100 which fits within a recess 101 in the tool housing surface quick connect means 42 to lock the attachment 92 in the installed position. The tab 100 further serves to provide a means of quick-release of the rotary tool 10 from the attachment 92. It will be understood that any suitable means can be applied to lock and release attachment 92 from the rotary tool. Similarly, other attachments can be fitted with multiple quick connect means for applications such as a drywall cutter, a panel trimmer, a “roto-zip” attachment, etc. The quick connect means 36 allows the rotary tool to be quickly removed from the base when the user requires use of the rotary tool.

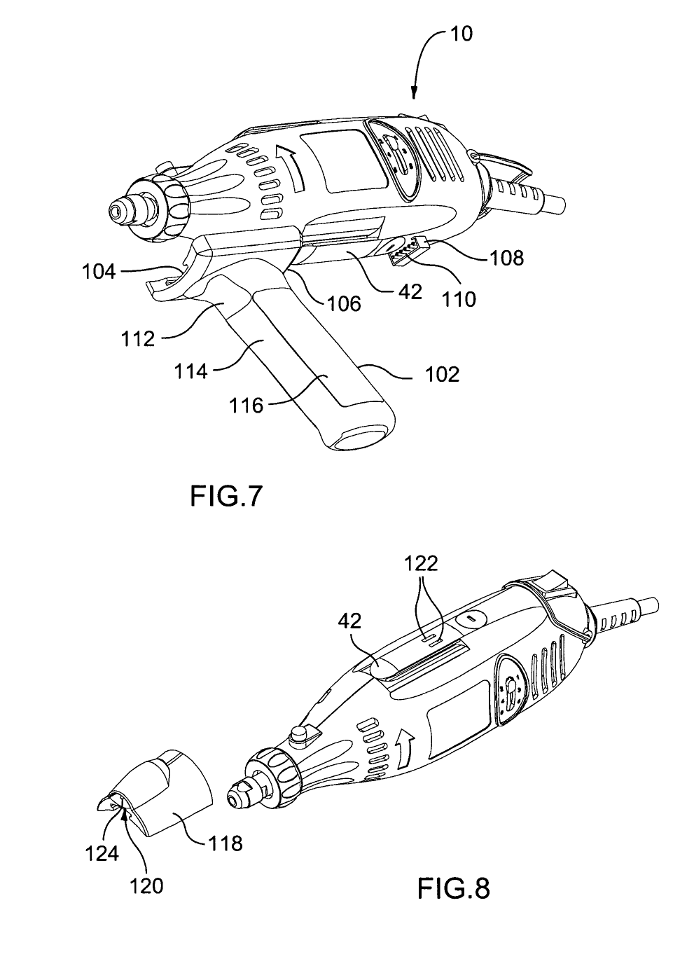

FIG. 7 provides another embodiment of a rotary tool having quick connect means. In this embodiment, the rotary tool 10 includes housing surface quick connect means 42 for receiving an attachment 102 with means for functionally integrating with the rotary tool 10. In this embodiment, the attachment 102 comprises mating means 104 cooperatively configured to fit with a dovetail connection of the housing surface quick connect means 42. The attachment 102 further comprises a contact section 106 to fit with a means for receiving the functionally integrated attachment, seen as a mating contact section 108, mounted on the rotary tool. The contact section 108 comprises electrically conductive pins 110 that are connected to means for controlling the motor housed in the rotary tool. The pins 110 further serve as an interface with respective electrically conductive contacts (not shown) in the contact section 106 of the attachment 102. When the attachment 102 is in an installed position, the mating of the contact sections 106 and 108 connects the contacts in the attachment contact section 106 with the corresponding pins 110 in the mating contact section 108 serving to close an electric circuit between the attachment 102 and the rotary tool 10. The attachment 102 further comprises a trigger 112 that is electronically connected to the contacts within the contact section 106 so that when the trigger is activated (i.e. pressed), the motor is turned on and begins to rotate. The attachment 102 further comprises ergonomically shaped surfaces 114 and 116 to provide a comfortable grip to the user.

When the attachment 102 is connected to the rotary tool 10, the trigger 112 operates as a user interface to control the electronic circuit between the attachment 102 and the rotary tool 10 and therefore control the rotation of the motor. The more the trigger 112 is pressed, the higher the rotational speed of the motor and conversely releasing the pressure on the trigger 112 causes the rotational speed of the motor to decrease. The trigger 112 may further control the motor to stop the rotation of the motor when the trigger is fully released. Several auxiliary features utilizing the benefits of this and other similar connections may be incorporated including but not limited to sensing devices and display devices.

FIG. 8 shows yet a further embodiment of a rotary tool having quick connect means. In this embodiment, the rotary tool 10 is adapted to receive an attachment by way of a functionally integrated electrical connection. As will be understood, this is only one of many types attachments which may be mounted in this manner. The attachment 118 comprises mating means 120 configured to cooperatively fit with the dovetail connection of the housing surface quick connect means 42. The housing surface quick connect means 42 comprise electrically conductive contacts 122 mounted within a surface of the housing surface quick connect means 42. The electrically conductive contacts 122 are mounted on the surface in a manner similar to how battery contacts are mounted to a surface.

The contacts 122 are connected to a power supply means within the rotary tool 10 and serve to interface with corresponding electrically conductive contacts (not shown) located on the underside of the mating means 120. When the attachment 118 is in the installed position, the connection between the contacts within the mating means 120 and the contacts 122 on the quick connect means 42 serve to close an electric circuit between the attachment 118 and the rotary tool 10 thereby provided power to the attachment 118 when the rotary tool 10 is in operation. In order to protect the user from injury, the open contact 122 is hidden from the user or the contact 122 is designed such that inadvertent contact by the user is harmless.

In the present embodiment, in order to assist the user in using the rotary tool, closing of the circuit by connecting the contacts in the attachment and the contacts 122 of the quick connect means 42, an indicator light bulb 124 is turned on to illuminate the work area. In a similar manner, the attachment may be a laser light attachment.

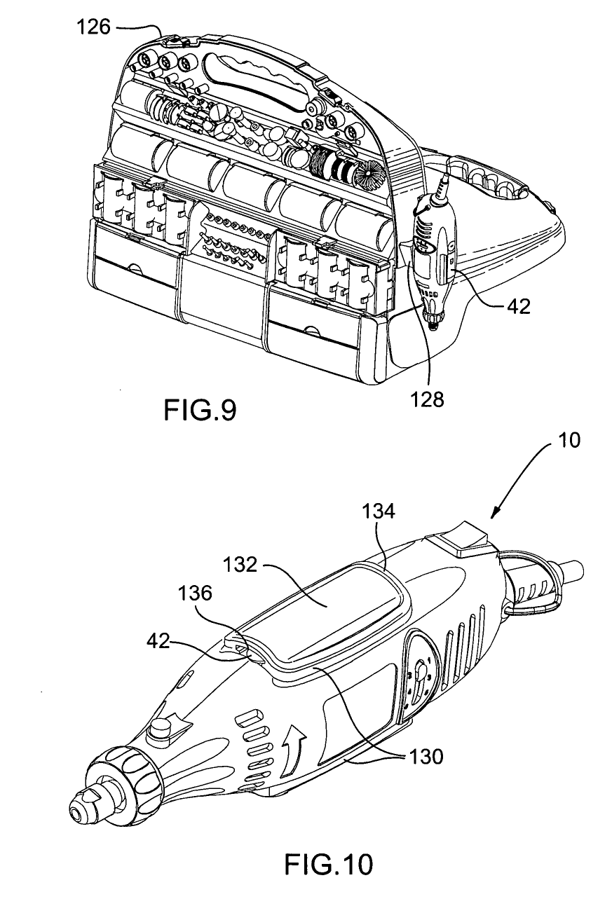

FIG. 9 shows another embodiment of a rotary tool with quick connect means attached to a rotary tool workstation or accessory case. In the figure, the rotary tool 10 is conveniently stored on the side of the workstation 126 but may be attached to any other location on the surface of the workstation provided the location has mating means for cooperating with the quick connect means 36 of the rotary tool. The workstation 126 includes an integral bracket 128, mounted on the side, such that the tool housing surface quick connect means 42 slides easily into the bracket for easy storage and removal of the tool from the workstation 126. The quick connect means of the present invention facilitates storage capability in other configurations as well. Furthermore, by attaching the rotary tool to the outside of the portable workstation, at the point of purchase, the consumer is able to see what is available with the workstation.

FIG. 10 shows another embodiment of a rotary tool having quick connect means for receiving an attachment. For some users, long periods of use and tool vibration contribute to the possibility of the user experiencing repetitive strain injuries (RSI), disorders or the like. In the present embodiment, the quick connect means receive at least one attachment designed to provide salutary or curative benefits. Each attachment 130 is a custom designed pad 132 manufactured from one or more materials specially configured to prevent or reduce RSI. This has particular application to the industrial sector. The preferred embodiment comprising two attachments 130 mountable to housing surface quick connect means 42 of the rotary tool 10. The attachments 130 comprise the shaped pad 132 with mating means 136 configured to cooperatively mate with the housing surface quick connect means 42. As described above, the mating means 136 are preferably shaped to mate with a dovetail connection of the housing surface quick connect means 42. The pad 132 is preferably manufactured from a gel material which absorbs, transfers, shields or removes harmful energy, vibration which may cause injury to the user while the rotary tool is in use. It will be understood that other materials (other than a gel material) may be contemplated and are suitable for such an application.

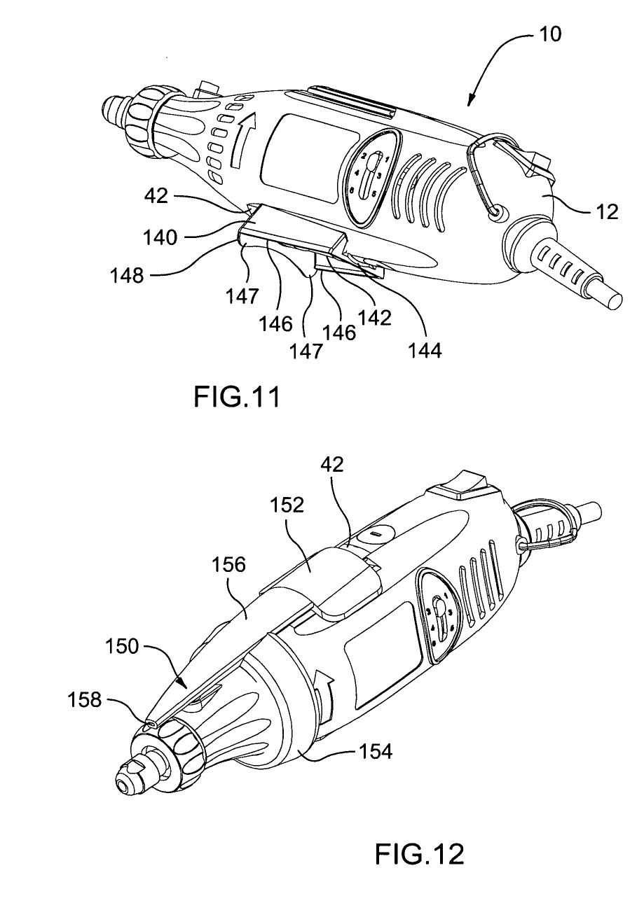

Turning to FIG. 11, a rotary tool having quick connect means for receiving an attachment 140 such as an anti-roll base is shown. This attachment 140 prevents cylindrical shaped tools, such as a rotary tool, from rolling so that the rotary tool 10 is stationary when not in use. The anti-roll base 140 further serves as a stand for temporary placement while the tool is not in use.

The anti-roll base 140 comprises a wall 142 with mating means 144 configured to cooperatively mate with the dovetail connection of the housing surface quick connect means 42. The attachment 140 further comprises a pair of side walls 146 extending downwardly away from the wall 142 and substantially angled respective to the top wall 142 along the longitudinal axis of the tool. A third wall 148 joins the ends of the pair of walls 146 and has a projection (seen as feet 147) which serves as a contact point between the attachment 140 and the work-surface when the rotary tool 10 is placed onto the work-surface.

FIG. 12 shows an attachment mounted to a rotary tool via quick connect means. The attachment, or blow-off tool, 150 is generally intended for use in discarding dust, chips or otherwise unwanted materials at the cutting area of the accessory and comprises an extension 152 for mounting to the rotary tool 10, an exhaust tunnel 154 and an air converging channel 156. The extension 152 further comprises mating means configured to cooperatively mate with the dovetail connection of the housing surface quick connect means 42. The exhaust tunnel 154 further comprises a hollow under-carriage to encapsulate the exhaust air vent 24 to direct the heated airflow to the channel 156. The channel 156 comprises a hollow section which converges in a cross section towards an orifice 158 adjacent to the tool end of the rotary tool 10. Similarly, a vacuum device may be attached to the air intake vent of the rotary tool, and a deflecting mechanism to prevent contaminants from being drawn into the air intake vent and to extract the unwanted material from the work area and out away from the rotary tool.

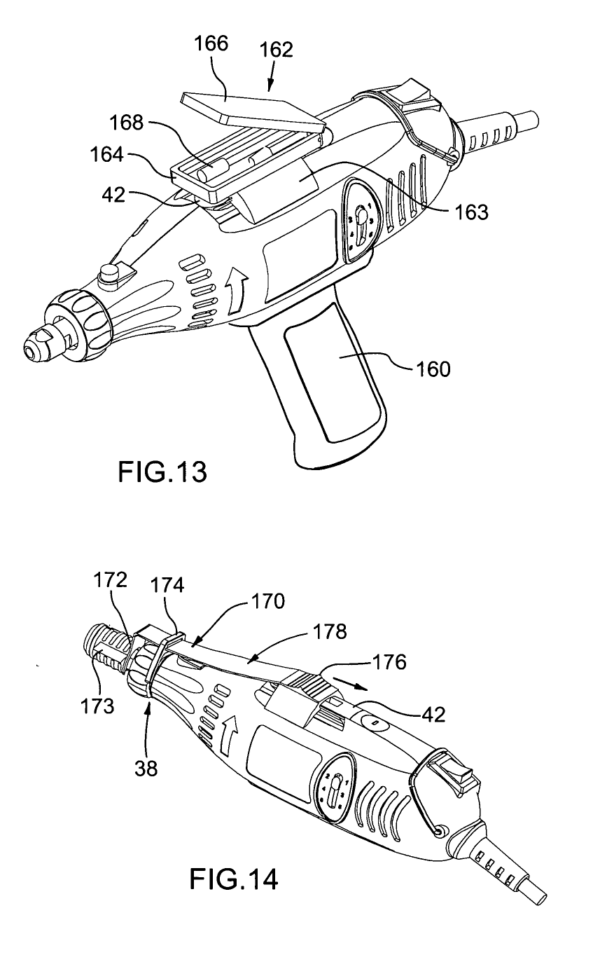

Turning to FIG. 13, a rotary tool having two attachments mounted via quick connect means is shown. As described above, the rotary tool 10 may comprise multiple housing surface quick connect means. In this embodiment, one of the housing surface quick connect means 42 is located at the top of the rotary tool and the other quick connect means is located the bottom of the rotary tool.

The two attachments thereby facilitates a multitude of uses for the user and it will be understood that any suitable combination of attachments are contemplated. In this embodiment, the two attachments are a handle 160 and an accessory container attachment 162. The container attachment 162 comprises mating means configured to cooperatively mate with the dovetail connection of the housing surface quick connect means 42 located at the top of the rotary tool. The container attachment 162 further comprises a box section 164 with a lid 166 cooperatively configured to the box section 164 to house accessories 168 within the container. Any suitable means may be used to retain or otherwise contain the accessories. The container attachment 162 is preferably used to house rotary tool accessories 168 in order to permit portability of accessories and remote use of the rotary tool. There are several possible configurations of the container attachment 162 for several different uses of accessories thereby resulting in a multitude of possibilities of configurations or construction.

As described above, the container attachment 162 may also be mounted to a hand held power tool with a bi-directional motor to house tool accessories for use with the hand held power tool with a bi-directional motor. The container attachment 162 is preferably beneficial for many other power tools, in the example of a drill, since the container attachment 162 may house power tool bits so that a user has easy and quick access to these bits.

The handle 160 also comprises mating means configured to cooperatively mate with the dovetail connection of the housing surface quick connect means 42 located at the bottom of the rotary tool. The user simply connects the mating means and the housing surface quick connect means 42 (as previously described above) and attaches the handle 160 to the rotary tool 10 to enhance the usability of the rotary tool.

FIG. 14 shows a chuck actuation attachment attached to the rotary tool via quick connect means. In this embodiment the housing surface quick connect means 42 are used in a different manner in that the quick connect means assist to guide the attachment in a sliding motion. It will be understood that there are other attachments that would benefit in a similar manner. Furthermore, the embodiment illustrates the different quick connect means may be used together to receive attachments.

A chuck attachment 173 is mounted to the spindle quick connect means 38 at the tool end of the rotary tool 10. The chuck actuator attachment 170 comprises a chuck interface 172, attachment connection means 174, a user interface 176 and a body 178. The chuck interface 172 comprises fork-like extensions to actuate the chuck in a longitudinal direction thereby actuating the chuck to release the accessory held within. The chuck attachment may be returned to a lock position manually with the actuator 170 or by spring biasing within the chuck. The chuck interface 172 permits free rotation of the chuck when the tool is in use. The attachment connection means 174 comprising mating means to mate with the tool housing end quick connect means 40 Alternatively, the connection may be achieved by using a spring clamp. The spring clamp construction permits the actuator 170 to be attached from the top of the tool which improves the functional requirements of the user. The connection means 174 further serving to guide the body 178 within. The user interface 176 comprises a button type gripping means for the user to initiate actuation. Actuation of the user interface 176 transfers motion to the body 178 guided by connection means 174 thereby actuating the chuck with the chuck interface 172.

In this embodiment, the multi-use of the quick connect means is further illustrated. The housing surface quick connect means 46 are used as axially guiding means for the attachment, the tool end quick connect means 40 are used as locking means for keeping the attachment in place and the spindle end quick connect means are used as locating means and for locking the chuck actuator attachment 170 to the rotary tool.

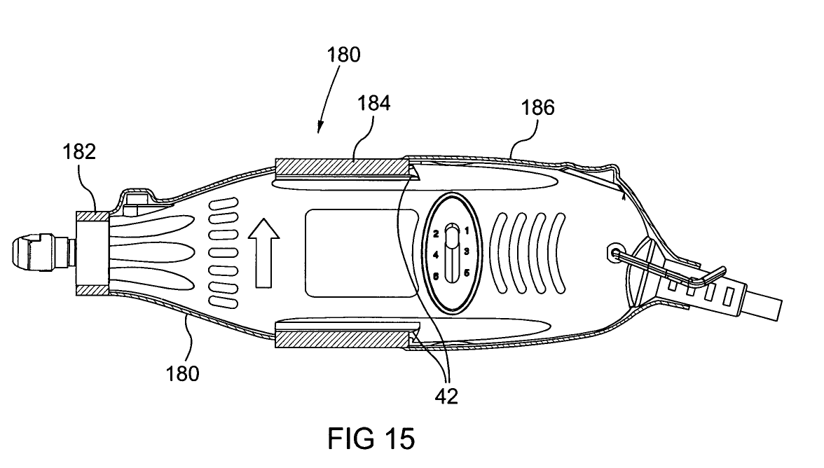

FIG. 15 shows a rotary tool having a protective boot attachment mounted thereon via quick connect means. The protective boot attachment 180 facilitates use of the rotary tool in outdoor or otherwise harsh environments for example, a chemical environment. The protective boot attachment 180 may be manufactured from various materials, and is preferably pliable, with the construction thereof designed to suit the intended environment of use. The attachment 180 preferably facilitates the use of the tool in environments otherwise not feasible with the known art.

The protective boot attachment 180 comprises mating means 184 for attaching the boot to the dovetail connection of the housing surface quick connect means 42. This allows the boot attachment 180 to be mounted to the rotary tool 10 while maintaining the boot attachment 180 longitudinally and rotationally in place as required. In the preferred embodiment, the protective boot attachment 180 (shown in section) comprises a housing collar 182, mating means 184 and a protective cover 186. The housing collar 182 is circular and shaped to fit onto the tool housing end quick connect means 40 and is secured to the protective cover 186. The mating means 184 are also secured to the protective cover so that the protective cover is a continuous cover. The protective cover 186 is optionally transparent can include additional material conducive to air flow secured into the locations over the exhaust and intake vents thereby permitting air flow for the proper function of the tool. The protective cover 186 is further constructed to provide and ensure an appropriate interface for the user to access the tool controls such as the power switch 16 and speed adjustment button 18. The protective cover 186 comprises an opening with closure means on the end opposite to the end with collar 182 which allows the protective cover to be initially wrapped around the rotary tool. The connection between the mating means and the dovetail connection prevents the protective cover from sliding during use.

Alternatively, the boot attachment 180 may be inserted onto the tool at the end with the tool housing end quick connect means 40 subsequently attached to the housing surface quick connect means 42 into an installed position and the closure means then employed. Closure means could include any suitable means such as a zipper, Velcro or a button flap.

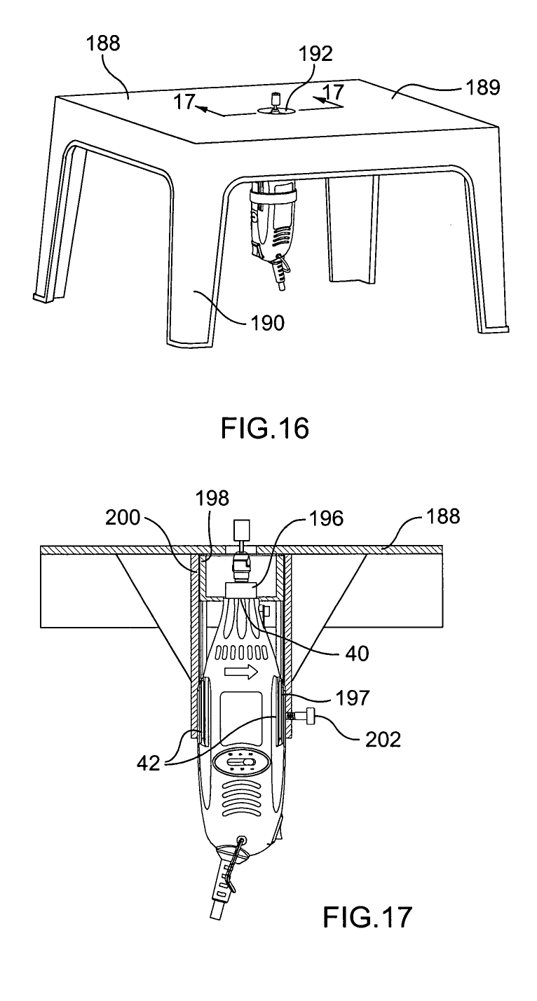

FIG. 16 displays a rotary mounted to a router or shaper table tool via quick connect means. The table 188 is generally rectangular in shape with a top surface 189 having a set of four legs 190 connected to a bottom of the top surface 189. The table also includes a cylindrical opening, or hole, 192 through a central area of the top surface 189. The underside of the top surface generally comprises means 194 which mates with the quick connect means of the rotary tool to mount the rotary tool to the table 188. Therefore, after the user is finished with the rotary tool, it may be easily disconnected from the table and used elsewhere.

FIG. 17 provides a sectional view, taken along line 17-17 of FIG. 16. The rotary tool contacts the table 188 via the tool housing end quick connect means 40 and the housing surface quick connect means 42 which are used as securing means, guiding means or adjustments means or combinations thereof.

In the preferred embodiment, the tool housing end quick connect means 40 cooperate with a locknut 196. The locknut 196 secures the tool end of the rotary tool to a sliding collar 198, the collar 198 provides guided adjustments when the rotary tool is sliding within the cylindrical opening 192 of the table 188. The table 188 also mates with the housing surface quick connect means 42 via a pair of mating means 197 located on support walls 199 on opposite sides of the table. The mating means further serve to guide the tool and sleeve 200 respective of the table 188.

A locking screw 202 is secured into table 188 and used for securing the connection between the table 188 and the quick connect means 42.

Similarly the rotary tool 10 may be connected to an attachment and be used as a profile sander. This embodiment further illustrates that the present invention facilitates support and multiple connection means for various rotary tool applications.

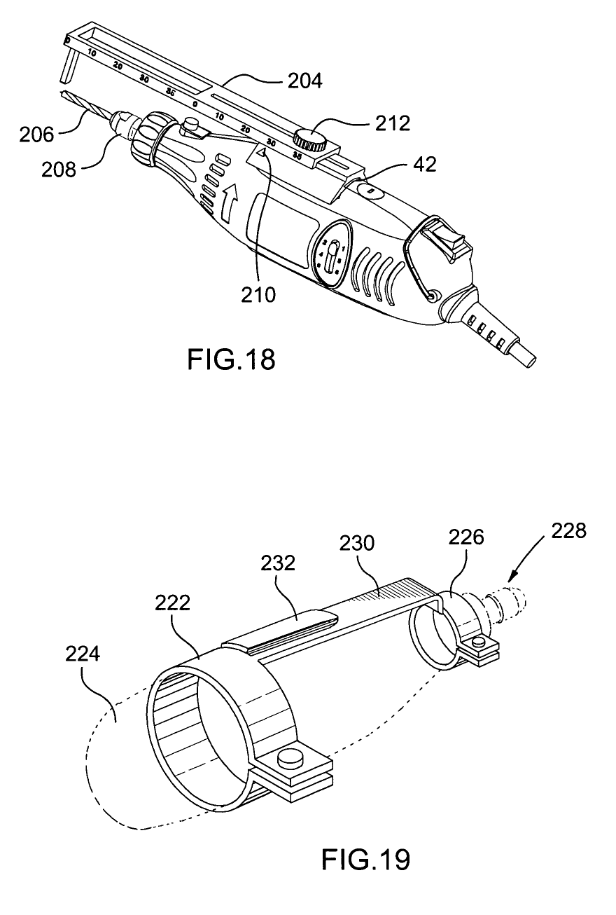

FIG. 18 is directed at an embodiment of a rotary tool having quick connect means for receiving an attachment such as a depth gauge attachment. Use of the depth gauge attachment 204 as the attachment illustrates how the quick connect means may provide longitudinal location referencing for the rotary tool. Other attachments are possible which provide other location referencing attachments for locating positions longitudinally or rotationally. In this embodiment, the gauge attachment 204 is secured onto the housing surface quick connect means 42. As previously described, the housing surface quick connect means 42 may include a stop wall 82. The stop wall 82 is preferably in a location relative to the end of the spindle. Accordingly, dimensional relationships are established from the depth gauge attachment through to an accessory 206 with associated interrelationships from the spindle to a chuck 208 and the chuck to the accessory 206, in this case the distal end of the accessory. The gauge attachment 204 can thereby measure accurately the depth at which the end of accessory 206 has been set to relative to the end of the chuck by reading the value adjacent to an indicator 210. This permits for readjustment as required. Alternatively, the user can set the gauge attachment 204 to drill holes to a predetermined depth. The gauge is first used to measure the location of the end of the accessory. The user subtracts the desired depth, adjusts the gauge and locks with thumbscrew 212.

FIG. 19 is a perspective view of a harness having quick connect means which may be mounted to a conventional rotary tool (shown in broken lines) in order to provide a rotary tool having quick connect means. The harness 220 comprises a first holder portion 222 which is mounted around the larger end of the rotary tool 224 and a second holder portion 226 which is mounted near a tool end 228 of the rotary tool 224. The harness 222 further comprises an attachment portion 230 which connects the first and second holder portions. On top of the attachment portion 230 is a quick connect means 232, seen as a dovetail connection.

Both holder portions 222 and 226 comprise securing means 234 which allow the harness to be secured to the rotary tool. The size (hole size) of the holder portions may be adjusted so that they are able to fit most conventional rotary tools. After attaching the harness to the rotary tool, the rotary tool may receive attachments having mating means for attaching with the quick connect means 232.

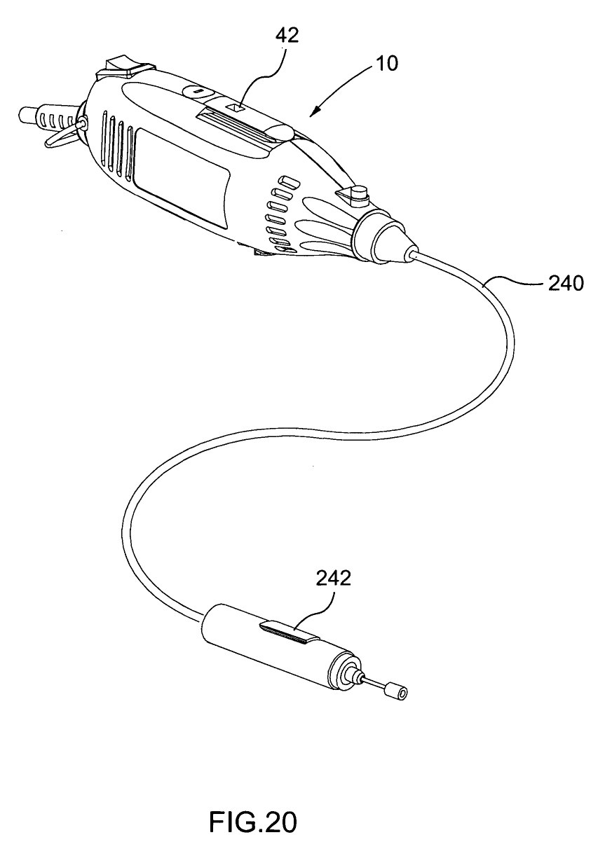

FIG. 20 is a perspective view of a rotary tool having quick connect means with a flex shaft connected to the rotary tool. The rotary tool 10 includes quick connect means 36 seen as the housing surface quick connect means 42. A flex shaft 240 is connected for use at the end of the rotary tool via the spindle end quick connect means 38 and the tool end quick connect means 40 in a manner similar to the one described above with respect to FIG. 3. At the tool end of the flex shaft, the flex shaft includes quick connect means 242, seen as a dovetail connection, which may receive attachments having mating means configured to cooperatively mate with the dovetail connection. Therefore since the use of the tool may be remote from the rotary tool, the presence of the quick connect means 242 allows a user to still connect attachments to the flex shaft to assist in the rotary tool application.

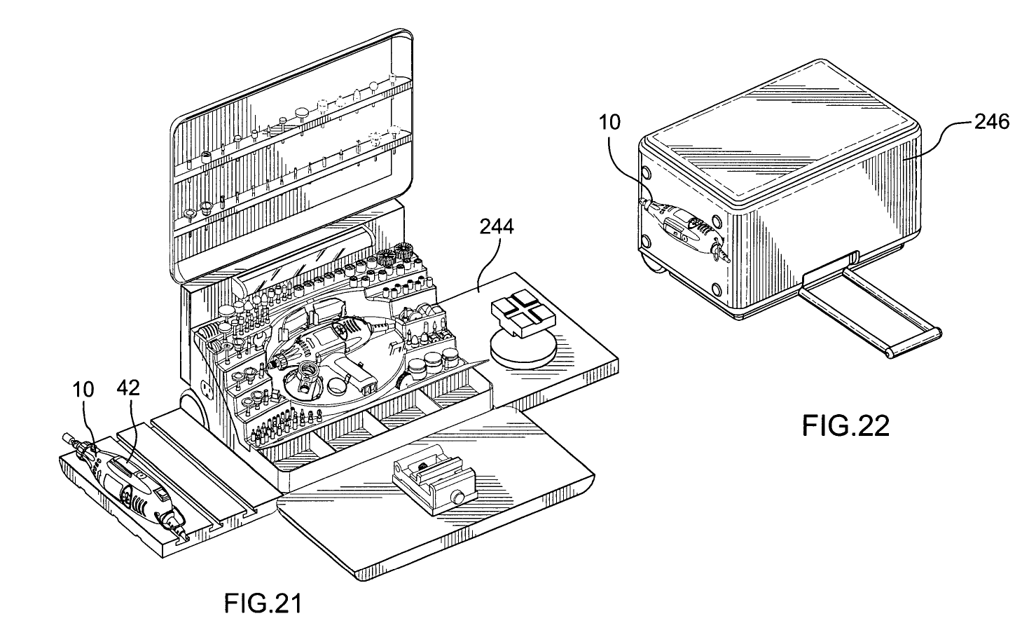

FIG. 21 is a perspective view of a rotary tool having quick connect means connected to a portable workstation. The rotary tool 10 includes housing surface quick connect means 42 which allow the rotary tool to be mounted to the portable workstation 244. By mounting the rotary tool to the portable workstation using the quick connect means, the rotary tool may also be quickly disconnected from the workstation once the user is finished with the tool in order to quickly provide a larger work space to the user. FIG. 22 shows the rotary tool connected to the portable workstation in a second position.

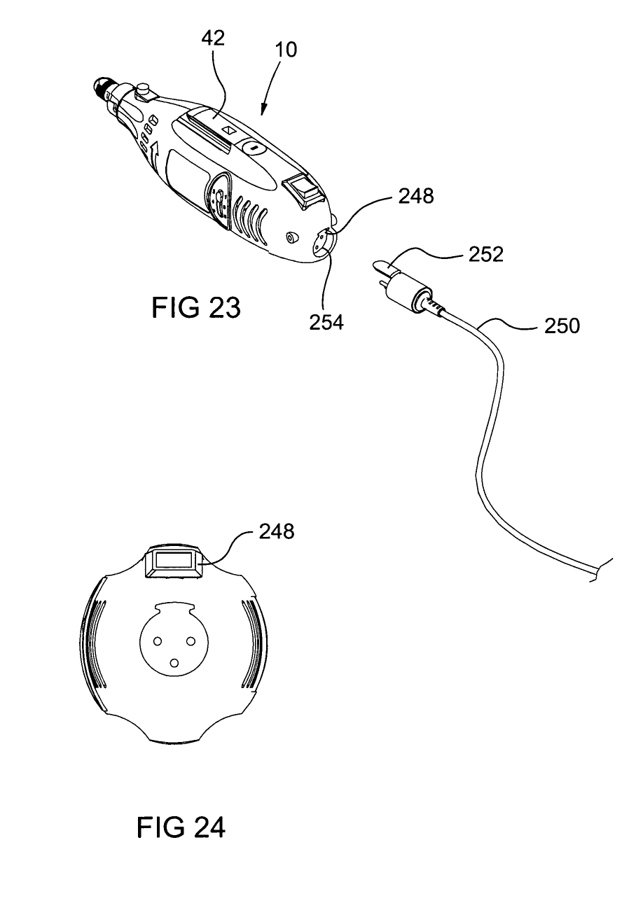

FIG. 23 is a perspective views of a rotary tool 10 having quick connect means 36 mounted to the outside of a tool case or portable workstation 246. The rotary tool may be easily and quickly attached to the tool case without having to open up the case. Therefore, if a user wishes to bring a rotary tool, the user does not have to open up the case to put it in but can simply connect the rotary tool 10 (via the housing surface quick connect means 42) to the corresponding mating means on the surface of the tool case/portable workstation 246.

Turning to FIG. 24, a perspective view of a rotary tool 10 having quick connect means 36 is shown. Along with the housing surface quick connect means 42, the rotary tool 10 also comprises a power end quick connect means 248. The power end quick connect means 248 is preferably a dovetail connection but it will be understood that other quick connect means such as a T-slot connection may be used. The power end quick connect means 248 is preferably used to guide a power cord 250 having mating means 252 which are configured to mate with the power end quick connect means 248 in order to guide the mating of the power cord with the power receptacle 254 in the rotary tool 10. The power receptacle is wired to the motor in order to provide power to the motor when the power cord is connected to the rotary tool and a power source (not shown).

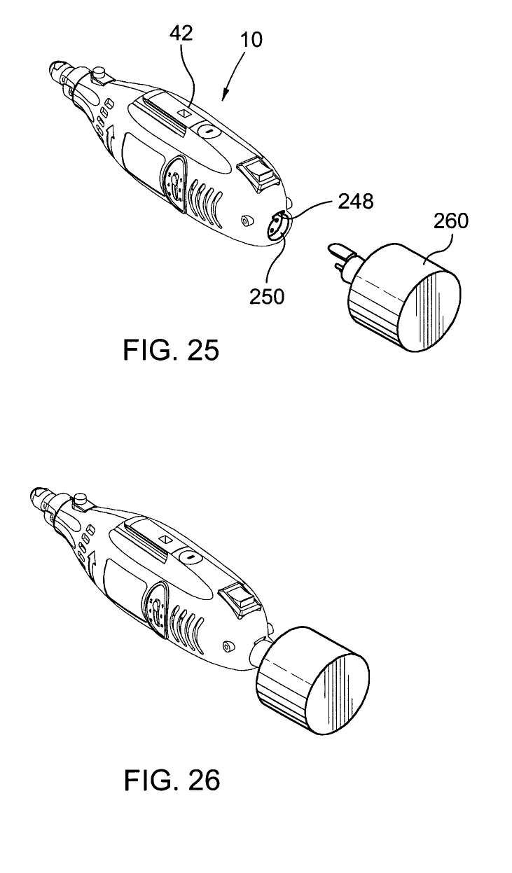

Turning to FIG. 25, a schematic diagram of a rotary tool having quick connect means is shown. The rotary tool is similar to the rotary tool of FIG. 24 with the difference being that the power end quick connect means 248 are configured to receive a battery pack 260 having mating means for cooperating with the power end quick connect means of the rotary tool. FIG. 26 shows the battery back connected to the rotary tool

Alternatively, a clip attachment may be mounted to the rotary tool via the quick connect means to hold a vacuum hose in place in order to extract unwanted materials from the work area. The clip attachment may also be used with the rotary tool when in the hand of the user. The clip attachment may be mounted on either or both of the housing surface quick connect means.

In another embodiment, a gear reduction unit attachment may be mounted to the rotary tool via the quick connect means. The gear reduction unit attachment may be mounted using any number of the quick connect means depending on the construction of the attachment. The gear reduction unit attachment preferably comprises a set of planetary gears or other suitable means to reduce the revolutions per minute of the rotary tool to that of a drill or other suitable tool. The gears would preferably be housed within a casing with an input shaft connectable to the spindle of the rotary tool and an output shaft connectable to a chuck accessory attachment. Similarly, a drive transfer may be applied for right angle attachments to convert rotation to reciprocation as in the case of a reciprocal converter for sawing motion as well as other such mechanisms.

In another embodiment, the rotary tool may be attached via the quick connect means to a swivel base with or without a bench clamp. The clamp can be mounted on the edge of a work-surface and the rotary tool affixed to a mating section which is configured to mate with the quick connect means which allows the rotary tool to be stationary and secured and the work-piece manipulated by the user. This arrangement allows the rotary tool to be held firmly in one position and provides flexibility in that the rotary tool may be positioned in a variety of positions to accomplish a wide range of tasks.

In another embodiment, a level may be attached to the rotary tool via the quick connect means to improve the functionality of the rotary tool for various applications. For example, if the user was drilling holes into a large work-piece, the power tool may be mounted onto a workbench with the level assisting in proper alignment of an accessory relative to the work-bench thereby allowing the user to drill the required holes moving the work-piece relative to the workbench.

In another embodiment, the rotary tool may be attached to a bench clamp via the quick connect means that in turn is fastened to the edge of a work-surface.

In yet another embodiment, the rotary tool can be attached via the quick connect means to a fixture to be used as a radial-arm saw, a drill press, etc. The quick connect means provides improved attachment means for such applications.

In another embodiment, an upright, rigid stand may be attached to the quick connect means of the rotary tool allowing the use of other attachments to be attached to the spindle end of the housing such as a flexible extension. The upright, rigid stand may also be adapted for height adjustability and further serve as a drill press.

In yet another embodiment, the quick connect means provides means for the rotary tool the ability to be connected with a circle cutter.

In another embodiment, the rotary tool having quick connect means may mate with a wall bracket having mating means to offer temporary tool placement for the user while freeing the hands for other tasks.

In yet another embodiment, a clear protective dust/spark shield may be connected to the quick connect means of the rotary tool. Such an attachment can be connected to any of the different quick connect means on the tool housing to provide extended capability for the user to operate the rotary tool in a safer environment.

In still another embodiment, a magnifying glass may be connected to one of the housing surface quick connect means of the rotary tool. There are accessories available in standard sets that are used for carving, etching, and other fine work, and having a magnifying glass becomes essential. Furthermore the magnifying glass may be used in conjunction with a task light as combined into one attachment or used as separate attachments.

In another embodiment, a template guide system can be attached to the quick connect means of the rotary tool for guiding the accessory in a predetermined path. The quick connect means facilitates improved use of such attachments.

In further embodiments, other attachments such as a cutting guide or a protractor can be attached to the quick connect means of the rotary tool.

In another embodiment, an actuator can be configured to act as a multi-positional spindle lock upon attachment to the tool. If a particular chuck were to be used that would require locking the spindle for an accessory change than this can provide actuation of the spindle lock closer to the user than that of typical spindle lock buttons. Similarly, an attachment such as this could be used as spindle brake to provide the user capability to bring the motor speed to a stop in a quicker manner. This would further serve to improve the safe use of the tool.

Other attachments include but are not limited to a grout remover, a lawn mower blade sharpener, and a multi-purpose cutting guide.

An advantage of the present invention is that the quick connect means allows the rotary tool to be switched between multiple functionality in a shorter period of time. Since the attachments may be easily disconnected from the rotary tool and new attachments immediately connected, there is time saved for the user in order to allow the user to complete their job in a timely fashion without having to face delays in unscrewing attachments and then screwing on the new attachments.

The accessory chuck attachment 44 and the spindle end quick connect means 38 further comprise locating, supporting, driving, locking and releasing means.

Therefore the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A handheld power tool with a rotational motor comprising:
means for receiving a tool accessory;
means for rotating said tool accessory; and
at least one quick connect means for use with power tool attachments.

2. The handheld power tool of claim 1 wherein said power tool is a rotary tool.

3. The handheld power tool of claim 1 further comprising at least two quick connect means for use with said power tool attachments.

4. The handheld power tool of claim 1 wherein said at least one quick connect means is selected from a group consisting of a spindle end quick connect means, a tool housing end quick connect means, a housing surface quick connect means and power end quick connect means.

5. The handheld power tool of claim 4 wherein said housing surface quick connect means are located on a surface of said handheld power tool.

6. The handheld power tool of claim 5 wherein said housing surface connect means comprise dovetail shaped connection means, T-slot connection means, a recess, a projection, or magnetic means.

7. The handheld power tool of claim 1 wherein said rotary tool further comprises a flex shaft connected to a tool end of said rotary tool.

8. The handheld power tool of claim 7 wherein said flex shaft comprises quick connect means.

9. The handheld power tool of claim 5 wherein said housing surface quick connect means are integrally moulded.

10. The handheld power tool of claim 9 wherein said integrally moulded housing surface quick connect means are injection mounted.

11. The handheld power tool of claim 1 further comprising locking means for securing said power tool attachment to said at least one quick connect means.

12. The handheld power tool of claim 1 wherein said at least one quick connect means is mounted to said handheld power tool.

13. The handheld power tool of claim 3 wherein said at least two quick connect means cooperate with each other for use with a power tool attachment.

14. The handheld power tool of claim 1 further comprising means for receiving functionally integrated attachments.

15. The handheld power tool of claim 14 wherein said means is a pin connection or an electrical connection.

16. A harness for providing quick connect means to a handheld power tool with rotational motor comprising:
a first holder portion for attachment to one end of said handheld power tool;
a second holder portion for attachment to a second end of said handheld power tool;
means for securing said first and said second holder portion to said handheld power tool;
an attachment portion connecting said first holder portion to said second portion; and wherein said attachment portion further comprises quick connect means for receiving a power tool attachment.

17. A handheld power tool attachment comprising:
at least one mating means for mating with quick connect means on a handheld power tool with rotational motor.

18. The handheld power tool attachment of claim 17 wherein said handheld power tool attachment is selected from a group consisting of an accessory chuck attachment, a cutting guide attachment, a handle, a router base attachment, a functionally integrated attachment, a light attachment, a laser attachment, a portable workstation, a salutary gel pad attachment, an anti-roll base attachment, a blow-off tool attachment, a container, a chuck actuation attachment, a protective boot attachment, a router table attachment, depth gauge attachment, a flex shaft attachment, a power cord attachment and a battery pack attachment.

19. The handheld power tool attachment of claim 17 further comprising at least two mating means for mating with a handheld power tool having multiple quick connect means.

20. The handheld power tool of claim 1 wherein said at least one quick connect means are used for guiding, locating, adjusting, supporting, driving, attaching, locking or releasing.

21. The handheld power tool of claim 5 wherein said housing surface quick connect means are assembled to said handheld power tool.

22. The handheld power tool attachment of claim 17 further comprising means for functionally integrating with said handheld power tool.

23. The handheld power tool of claim 21 wherein said means is a pin connection or an electrical connection.
